(19) United States
(12) Patent Application Publication
(10) Pub. No.: US 2006/0098564 A1
(43) Pub. Date: May 11, 2006

(54) Information recording medium, information recording and reproducing apparatus and method for adjusting phase of recording track

(75) Inventors: Toshinori Sugiyama, Ibaraki-shi (JP); Reiji Tamura, Ibaraki-shi (JP); Tamotsu Iida, Ibaraki-shi (JP); Yoshikazu Mitsui, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/052,808

(22) Filed: Feb. 9, 2005

(30) Foreign Application Priority Data
Feb. 10, 2004 (JP) 2004-033431
Mar. 11, 2004 (JP) 2004-069773

(51) Int. Cl. G11B 7/24

(52) U.S. Cl. 369/275.3

(57) ABSTRACT

An information-recording medium of write once or rewritable type designed to have narrow tracks is provided, in which the wobble signal amplitude is scarcely fluctuated by crosstalk. The medium includes recording tracks formed in a spiral form and meandering at a predetermined wobble cycle T, and a plurality of zones constituting each of the recording tracks, each of the zones having a principal area formed to have a predetermined wobble phase. A relationship of T>80b holds between the wobble cycle T and a channel bit length b of recording data. The wobble phase of one of the recording tracks is adjusted so that an average phase difference d is d>π/2 between the wobble phase in the principal area in the zone and a wobble phase of an area in the recording track disposed adjacently on an inner circumferential side or an outer circumferential side of the principal area, in relation to all of the recording tracks disposed adjacently in the radial direction.

### BACKGROUND OF THE INVENTION

1. Field of the Invention

The present invention relates to an information-recording medium, an information-recording/reproducing apparatus, and a phase-adjusting method for a recording track. In particular, the present invention relates to an information-recording medium having a wobble groove capable of performing high density recording, an information-recording/reproducing apparatus, and a phase-adjusting method for a recording track.

2. Description of the Related Art

In the field of the optical disk as one of information-recording media, ROM media such as CD and DVD come into widespread use, in which large capacity recording information can be cheaply replicated by only transferring prepits previously formed on a stamper by the forming process. Write-once type media such as CD-R and DVD-R and rewritable type media such as CD-RW and DVD-RW, which are playback-interchangeable with the ROM media, are also come into widespread use.

However, in the technical field of the information-recording medium, the improvement in the recording density is a technical task which is more and more important as the information society is advanced. In such circumstances, in order to improve the surface recording density by improving the linear recording density along the information track and narrowing the track pitch, an optical disk, for example, those based on the medium standard of HD DVD are suggested, in which the blue-violet laser is used as a laser light source during the recording and reproduction to shorten the laser wavelength so that the spot diameter of the laser beam is reduced to improve the recording density.

In the case of the rewritable medium included in HD DVD, a narrow track arrangement having a track pitch of 340 nm (spacing distance between grooves: 680 nm) has been realized, in which the land-groove structure is adopted. Information is recorded on lands and grooves respectively on the rewritable type HD DVD by using an information-recording/reproducing apparatus provided with a laser light source having a wavelength of 405 nm and an objective lens having a numerical aperture of 0.65 of the objective lens. In this case, when PRML (combination of the partial response and the maximum likelihood code) is adopted, it is possible to realize a high linear density having a shortest bit length of 130 to 140 nm, in which the realization of large capacity has been achieved such that the recording capacity is 20 GB with the CD size.

On the other hand, in the case of the read-only ROM medium included in HD DVD, it is difficult to adopt the land-groove structure, because information is recorded with concave/convex pits. Therefore, the track of the ROM medium of HD DVD is constructed to have a track pitch of 400 nm which is somewhat wider than that of the rewritable type HD DVD. In order to easily manufacture the mastering, the shortest bit length of the ROM medium of HD DVD is constructed to have a bit length of 150 nm which is somewhat longer than that of the rewritable type HD DVD. As for the ROM media of HD DVD having the specification as described above, the realization of large capacity has been achieved such that the recording capacity is 15 GB with the CD size. The ROM medium of HD DVD has the low linear recording density as compared with the rewritable type HD DVD as described above. However, it is desirable to use the PRML system in order to use the signal reproduction processing common to the rewritable HD DVD.

In order to realize a write-once or rewritable type HD DVD while securing the interchangeability with the ROM medium of HD DVD as described above, it is necessary to recognize the address even when the recording is not performed. For example, Japanese Patent Application Laid-open No. 2000-163809 suggests a system for expressing the address of an information-recording medium by meandering the groove in accordance with a predetermined law.

It is desirable that the phase modulation, which is simple and which has the high detection accuracy, is adopted as the system for modulating the wobble in order to express the address. Such a system is adopted, for example, for the disks of DVD+R and DVD+RW which have the same size as that of CD and which have a recording capacity of 4.7 GB.

### SUMMARY OF THE INVENTION

Taking the convenience of the user into consideration, it is indispensable to realize a write-once or rewritable type HD DVD having the playback interchangeability with the ROM medium of HD DVD as described above. However, in order to realize such a write-once or rewritable HD DVD, it is necessary to solve various problems including, for example, problems concerning the specification and problems caused by the narrow track arrangement (problems of crosstalk or the like). Accordingly, an object of the present invention is to provide an information-recording medium having a recording track most suitable for the information-recording medium (with a narrow track arrangement) capable of performing the high density recording like the write-once or rewritable type HD DVD, and a recording and reproducing apparatus for the same.

According to a first aspect of the present invention, there is provided an information-recording medium on which information is write once or rewritable, the information-recording medium comprising:

recording tracks which are formed in a spiral form and which meander or wobble at a predetermined wobble cycle T; and

a plurality of zones which constitute each of the recording tracks, each of the zones having a principal area formed to have a predetermined wobble phase, wherein:

the following relationship holds between the wobble cycle T and a channel bit length b of recording data:

T>80b; and

the wobble phase of the predetermined zone of one of the recording tracks is adjusted so that an average phase difference d between the wobble phase in the principal area in the zone and a wobble phase of an area in the recording track disposed adjacently on an inner circumferential side or an outer circumferential side of the principal area is as follows in relation to all of the recording tracks:

d>π/2.

In the information-recording medium according to the first aspect of the present invention, a length of the predetermined zone may be adjusted so that the average phase difference d is d>π/2.

In the information-recording medium according to the first aspect of the present invention, a wobble phase of an area other than the principal area in the zone may be opposite to the wobble phase of the principal area, and the length of the zone may be an integral multiple of T/2.

In the information-recording medium according to the first aspect of the present invention, wobbles, which are formed in the principal areas of predetermined zones disposed adjacently in a circumferential direction, may have the phases which are opposite to one another.

In the information-recording medium according to the first aspect of the present invention, a wobble amplitude of at least a part of an area other than the principal area in the zone may be different from a wobble amplitude of the principal area.

In the information-recording medium according to the first aspect of the present invention, an identifier, which indicates a boundary of the zone, may be provided at one end of the zone in a circumferential direction.

According to a second aspect of the present invention, there is provided an information-recording medium on which information is write once or rewritable, the information-recording medium comprising:

recording tracks which are formed in a spiral form and which meander at a predetermined wobble cycle T; and

a plurality of zones which constitute each of the recording tracks, each of the zones having a principal area formed to have a predetermined wobble phase, wherein:

the following relationship holds between the wobble cycle T and a channel bit length b of recording data:

T>80b; and

the wobble phase of the predetermined zone of one of the recording tracks is inverted so that an average phase difference d between the wobble phase in the principal area in the zone and a wobble phase of an area in the recording track disposed adjacently on an inner circumferential side or an outer circumferential side of the principal area is as follows in relation to all of the recording tracks:

d>π/2.

In the information-recording medium according to the second aspect of the present invention, an identifier may be provided at one end of the zone in a circumferential direction, the identifier expressing information about a wobble phase of another zone disposed adjacently to the end.

In the information-recording medium according to the second aspect of the present invention, a length of the zone may be 1/n time an ECC block unit provided that n is an integer.

In order to realize a write-once or rewritable type medium of HD DVD while securing the interchangeability with the ROM medium, it is necessary that the address of the information-recording medium should be recognized even when the recording is not performed as described above. For this purpose, it is preferable to adopt the system in which the track groove is meandered in accordance with a predetermined law to express the address of the information-recording medium. In order to simplify the address detection on the write-once type HD DVD, it is preferable to adopt the wobble address expression of the phase modulation type which is adopted for the rewritable type HD DVD. Further, in the case of the write-once type HD DVD, it is desirable to use the CLV recording in order to secure the interchangeability with the ROM medium of HD DVD.

However, when the CLV recording is adopted for the recording system, a variety of wobble phase relationships exist between the tracks which are disposed adjacently in the radial direction. When the spacing distance between the grooves of the write-once type HD DVD is subjected to the narrow track arrangement so that the spacing distance is about 0.4 μm in conformity with the ROM medium of HD DVD, the influence of the crosstalk exerted from the adjoining track is increased. Therefore, a problem arises such that the degree of the influence of the crosstalk differs depending on the position in the medium as well, because a variety of wobble phase relationships exist between the tracks disposed adjacently in the radial direction, when the spacing distance between the grooves is about 0.4 μm on the write-once type HD DVD which adopts the CLV recording.

The problem as described above will be specifically explained with reference to FIG. 2. When the CLV recording is performed on the medium subjected to the narrow track arrangement, an ideal wobble signal waveform is a signal waveform as shown in FIG. 2B, for example, when the wobble signal is detected from a wobble groove as shown in FIG. 2A. An area 21, in which the wobble phase is inverted with respect to the wobble phase of an area 20 shown in FIG. 2A, is, for example, such an area that the address is recorded. However, as described above, in the case of the CLV recording, the wobble phase relationship differs between the tracks disposed adjacently in the radial direction, depending on the position in the information-recording medium. Therefore, the influence of the crosstalk exerted by the adjoining track differs as well. Therefore, even in the case of the recording tracks having an identical wobble pattern, a wobble signal as shown in FIG. 2C is detected in some cases, and a wobble signal as shown in FIG. 2D is detected in other cases, depending on the position in the information-recording medium. That is, for example, the amplitude of the wobble signal obtained from the area 20 shown in FIG. 2 greatly varies or fluctuates depending on the position in the information-recording medium. Specifically, it has been revealed that the ratio between the minimum value and the maximum value of the wobble signal amplitude is not less than two-fold. Each of FIGS. 2C and 2D is illustrative of the case in which the amplitude of the wobble signal is constant in the area 20 and in the area 21 in which the wobble phase is inverted with respect to the area 20 by way of example. However, in general, the relationship of the wobble phase differs with respect to the track area disposed adjacently in the radial direction even in the areas 20, 21. Therefore, the amplitude of the wobble signal changes in the respective areas as well.

As shown in FIGS. 2C and 2D, the following fact has been revealed as a result of detailed analysis of the cause of the great variation or fluctuation of the amplitude of the wobble signal depending on the position in the information-recording medium. That is, the amplitude of the wobble signal is minimized when the wobble phase of a predetermined recording track is approximately the same as the wobble phase of recording tracks disposed adjacently on the both sides thereof in the radial direction. The amplitude of the wobble signal is maximized when the former wobble phase is approximately opposite to the latter wobble phase.

Further, the following fact has been revealed as a result of the geometrical analysis performed on the assumption that the predetermined recording track is designated as “track n”, and the recording tracks disposed adjacently on the inner circumferential side and the outer circumferential side are designated as “track n−1” and “track n+1” respectively. That is, the wobble phase of the predetermined recording track is approximately the same as the wobble phases of the recording tracks disposed adjacently on the both sides of the recording track in the radial direction when each of the track length L0 of the spiral track ranging from the track n−1 to the track n and the track length L1 of the spiral track ranging from the track n to the track n+1 is approximately an integral multiple of the wobble cycle T or a multiple obtained by multiplying the wobble cycle T by an integer.

One method, which is conceived to solve the problem (problem of crosstalk) caused by the wobble phase relationship between the recording tracks disposed adjacently in the radial direction as described above, may be exemplified by a method in which the wobble cycle T is about 4πP provided that P represents the track pitch. When the condition as described above is satisfied between the wobble cycle T and the track pitch P, the track length L1 of the spiral track ranging from the track n to the track n+1 is geometrically L1=L0+2πP=L0+T/2, even when the length L0 of the spiral track ranging from the track n−1 on the inner circumferential side to the track n is an integral multiple of the wobble cycle T for an arbitrary recording track n. Therefore, the wobble phase of the track n is opposite to the wobble phase of the track n+1.

Therefore, when the condition as described above (T≈4πP) is satisfied between the wobble cycle T and the track pitch P, the wobble phase of the predetermined track is not same as or not opposite to both of the wobble phases of the tracks on the both sides disposed adjacently in the radial direction. Therefore, it is possible to uniformize the influence of the crosstalk over the entire region of the information-recording medium, and it is possible to reduce the amplitude variation or fluctuation of the wobble signal, which would be otherwise caused by the crosstalk. When this wobble construction condition is adopted for the write-once type HD DVD having a track pitch of 0.4 μm, it is possible to reduce the amplitude variation or fluctuation of the wobble signal by making the wobble cycle T to be T≈4πP=5 μm.

On the other hand, in the case of the write-once type HD DVD, it is desirable to adopt the partial response system in order to secure the reading interchangeability with respect to the rewritable type as described above. However, in this situation, if the wobble cycle T is shortened, the following problem arises. In the partial response system, the level of the sum signal is multi-valued to improve the recording signal density. Therefore, it is necessary that the level fluctuation of the sum signal is suppressed to be low. Therefore, when the wobble is formed on the recording track, it is feared that the sum signal may be subjected to the level fluctuation on account of the wobble cycle, and any erroneous detection may occur. In order to avoid the erroneous detection as described above, it is necessary that the level fluctuation of the sum signal to be caused by the wobble should be removed by using a high pass filter. However, for this purpose, it is necessary that the frequency of the wobble signal is made sufficiently low with respect to the frequency of the data signal.

In the case of HD DVD, PR (1,2,2,2,1) is adopted, and the ETM modulation is adopted for the modulation system. Therefore, the longest data length is 11b (b represents the channel bit length). A periodic signal of a mark having a length of 11b and a space having a length of 11b, i.e., a periodic signal of data is generated, which has a longest length of about 20b. The following condition is preferred in order that the high pass filter is used to completely transmit the periodic signal of data and completely cut off the wobble signal. That is, the cutoff frequency of the high pass filter is about twice the longest cycle of data, and the cutoff frequency is about ½ of the wobble cycle. Therefore, assuming that the wobble cycle is T, it is desirable that the wobble cycle T is not less than about four times the longest cycle of data (20b), i.e., a relationship of “wobble cycle T≧80b” is satisfied.

The bit length is 150 nm in the case of the write-once type HD DVD having a recording capacity of 15 GB. However, the channel bit length b is 100 nm which is ⅔ time the bit length, because the ETM modulation is adopted. Therefore, in order to solve the problem caused when the partial response system is adopted as described above, it is necessary that the wobble cycle T is not less than 80b=8,000 nm=8 μm. However, as described above, the condition, under which the amplitude fluctuation of the wobble signal due to the crosstalk is reduced, is the wobble cycle T≈5 μm. Therefore, it is impossible to simultaneously satisfy the both conditions. That is, in the case of the write-once type HD DVD, when the wobble cycle T≈5 μm is given in order to reduce the amplitude fluctuation of the wobble signal due to the crosstalk, it is impossible to completely effect the band separation for the data signal and the wobble signal. On the contrary, when the wobble cycle T is not less than 8 μm in order to completely effect the band separation for the data signal and the wobble signal, it is impossible to reduce the amplitude fluctuation of the wobble signal due to the crosstalk.

The present invention has been made in order to solve the problem as described above. An object of the present invention is to provide an information-recording medium of the write-once type or the rewritable type on which high density recording can be performed (narrow track arrangement is achieved), wherein the amplitude fluctuation of the wobble signal due to the crosstalk can be reduced even when the wobble cycle T is sufficiently increased in order to adopt the partial response system.

The information-recording medium of the present invention is an information-recording medium on which information is write once or rewritable and on which a recording track meandering at a predetermined wobble cycle T (μm) is formed in a spiral form. The information-recording medium of the present invention is shown, for example, in FIG. 3, wherein the recording track is composed of a plurality of zones, and each of the zones is principally composed of an area in which the phase of a part of the wobble area is inverted (PA field 33 and a field 31 including address information as shown in FIG. 3), and an area in which the wobble phase is not inverted, i.e., an area in which the wobble is formed to have a predetermined wobble phase (unity field 32 as shown in FIG. 3).

In this specification, the wobble area, which occupies the greater part of the zone and which is formed to have a predetermined wobble phase (normal phase or opposite phase), is referred to as “principal area”. For example, with reference to FIG. 3 by way of example, the unity field 32, the wobble field or area 36 in the field 31 including the address information, and the wobble field of area 38 in the PA field 33 is the wobble field or areas which have the same phase and which occupy the greater part of the zone. Therefore, these areas constitute the “principal area”. Those not included in the principal area are the area 37 in which the wobble phase is opposite to that of the areas as described above and in which the address information is recorded, and the area of the identifier 39 which indicates, for example, the boundary of the zone.

In the case of the information-recording medium of the present invention, the wobble phase of the predetermined zone is appropriately adjusted so that the average phase difference d between the wobble phases of the tracks disposed adjacently in the radial direction is larger than π/2 over the approximately entire region of the information-recording medium (so that the wobble phases of the tracks disposed adjacently in the radial direction approach the opposite phase relationship more closely) in order that that the amplitude fluctuation of the wobble signal, which would be otherwise caused by the crosstalk, is reduced, even when the wobble cycle T of the recording track is made sufficiently longer than the channel bit length b (μm) of the write once or rewritable data in order to adopt the partial response system, specifically even when T>80b is given. It is noted that the average phase difference d, which is referred to in this specification, is the average value of the wobble phase difference per 1 track. However, the present invention is not limited thereto. For example, the average value obtained for the zone unit is also available.

The wobble structure or arrangement of the recording track of the information-recording medium of the present invention will be briefly explained with reference to FIG. 1. FIG. 1 shows the relationship of the wobble phases of the area 11 as a part of the principal area of a predetermined zone in the nth track (hereinafter referred to as “track n”) and the areas 10 and 12 of the (n−1)th and (n+1)th tracks disposed adjacently on the inner circumferential and the outer circumferential side of the area 11 respectively. FIGS. 1A to 1C also show the wobble phase difference between the track n and the track n−1 and the wobble phase difference between the track n and the track n+1 at broken line positions A.

As described above, in the case of the CLV recording system, as shown in FIG. 1A, the wobble phase of the area 11 in the track n is approximately the same as the wobble phases of the area 12 in the track n+1 and the area 10 in the track n−1 disposed adjacently on the outer circumferential side and the inner circumferential side of the area 11 respectively, depending on the position in the information-recording medium in some cases (in the example shown in FIG. 1A, the phase difference is 0.05π in both cases). When the wobble signal is detected from the area 11 of the track n in which the wobble phase relationship as shown in FIG. 1A is established, the amplitude of the wobble signal is decreased due to the influence of the crosstalk exerted from the adjoining tracks. However, in the case of the information-recording medium of the present invention, as shown in FIG. 1B or 1C, the wobble phase of the recording track is adjusted so that both of the wobble phase difference between the area 11 of the track n and the area 10 of the track n−1 and the wobble phase difference between the area 11 of the track n and the area 12 of the track n+1 are larger than π/2 over the entire region of the recording track of the information-recording medium. In the examples shown in FIGS. 1B and 1C, the wobble phase is adjusted so that the phase difference at the broken line position A is 1.05π (approximately opposite phase) for the both cases.

The procedure of method for adjusting the phase difference between the wobble phases of the recording tracks disposed adjacently in the radial direction is as follows. At first, the wobble phase difference d between the recording tracks disposed adjacently in the radial direction is determined. Subsequently, a predetermined phase is added to the wobble phase of a predetermined zone included in at least one recording track of the recording tracks disposed adjacently in the radial direction so that the wobble phase difference d is d>π/2 between the recording tracks disposed adjacently in the radial direction in which the wobble phase difference d would be otherwise d≦/2. Subsequently, the procedure as described above is executed for all of the recording tracks of the information-recording medium. Methods conceived as specified methods for adding the predetermined phase to the wobble phase of the predetermined zone included in the recording track include a method in which the length of the predetermined zone is adjusted and a method in which the wobble phase of the predetermined zone is inverted for the zone unit.

FIG. 1B shows the method for adjusting the wobble phase difference between the adjoining recording tracks by adjusting the zone length. In the example shown in FIG. 1B, a wobble (not shown) corresponding to a half cycle (T/2) is added to the aftermost tail of the zone including the area 10 of the track n−1, and a wobble (not shown) corresponding to a half cycle (T/2) is added to the aftermost tail of the zone including the area 11 of the track n. When the wobble corresponding to the half cycle is added to the aftermost tail of the zone including the area 10 of the track n−1, the wobble phase of the area 11 of the track n is deviated by a phase (π(rad)) corresponding to the half cycle relatively with respect to the area 10 of the track n−1. As a result, as shown in FIG. 1B, the wobble phase difference d between the track n and the track n−1 at the broken line position A is d=0.05π+π=1.05π, in which the opposite phase relationship is approximately established. Similarly, when the wobble corresponding to the half cycle is added to the aftermost tail of the zone including the area 11 of the track n, the wobble phase of the area 12 of the track n+1 is deviated by a phase (π(rad)) corresponding to the half cycle relatively with respect to the area 11 of the track n. As a result, as shown in FIG. 1B, the wobble phase difference d between the track n and the track n+1 at the broken line position A is d=0.05π+π=1.05π, in which the opposite phase relationship is approximately established.

FIG. 1C shows the method for adjusting the wobble phase of the recording track by reversing or inverting the wobble phase of the predetermined zone for the zone unit. In the example shown in FIG. 1C, the wobble phase of the zone including the area 11′ of the track n is inverted. When the wobble phase of the zone including the area 11′ of the track n is inverted as shown in FIG. 1C, the wobble phase difference d between the track n and the track n−1 at the broken line position A is d=0.05π+π=1.05π, in which the opposite phase relationship is approximately established as shown in FIG. 1C. Similarly, the wobble phase difference d between the track n and the track n+1 at the broken line position A is also d=0.05π+π=1.05π, in which the opposite phase relationship is approximately established.

When the wobble phase adjustment as shown in FIG. 1B or 1C is performed for all of the recording tracks of the information-recording medium upon the formation of the recording tracks, it is possible to manufacture the information-recording medium having such a wobble structure that the average phase difference d is d>π/2 between the wobble phase in the principal area in the zone and the wobble phase in the recording track area disposed adjacently on the inner circumferential side or the outer circumferential side of the principal area for all of the recording tracks. The wobble phase difference between the tracks adjoining in the radial direction may be adjusted by appropriately combining the method for adjusting the length of the predetermined zone (method shown in FIG. 1B) and the method for inverting the phase of the predetermined zone for the zone unit (method shown in FIG. 1C).

As described above, the information-recording medium of the present invention has such a wobble structure that the average phase difference d is d>π/2 between the wobble phase in the principal area in the zone and the wobble phase in the area of the recording track disposed adjacently on the inner circumferential side or the outer circumferential side of the principal area, in relation to all of the recording tracks. Therefore, the amplitude of the wobble signal obtained from the principal area is increased, and the size or magnitude of the amplitude of the wobble signal obtained from the principal area is also approximately identical over the entire region of the information-recording medium. Thus, it is possible to suppress the amplitude fluctuation of the wobble signal. Specifically, in the case of the information-recording medium of the present invention, for example, the wobble signal as shown in FIG. 2D can be stably obtained over the entire recording track of the information-recording medium.

The information-recording medium of the present invention is adjusted so that the average phase difference d is d>π/2 (rad) between the wobble phase of the principal area and the wobble phase of the area disposed adjacently to the principal area in the radial direction, in relation to all of the recording tracks of the information-recording medium as described above. However, the average phase difference d′ is d′<π/2 (rad) between the wobble phase of a certain area and the wobble phase of another area disposed adjacently to the certain area in the radial direction, in relation to the certain area other than the principal area (area having the phase opposite to the wobble phase of the principal area), for example, in relation to an area of a part of the address area. For this reason, the degree of the influence of the crosstalk exerted from the adjoining track differs between the principal area and the area other than the principal area. Therefore, the amplitudes of the wobble signals obtained from these areas also different from each other respectively.

Therefore, in order to obtain wobble signals having approximately identical amplitudes over the entire region of the information-recording medium, it is preferable that the wobble amplitude of at least a part of the area other than the principal area (area having the phase opposite to the wobble phase of the principal area) has a different magnitude or size as compared with the wobble amplitude of the principal area of each of the zones. When the wobble amplitude of the area having the phase opposite to the wobble phase of the principal area is appropriately adjusted as described above, it is possible to obtain a wobble signal having approximately uniform amplitudes, for example, as shown by a broken line in FIG. 2E. That is, the improvement is made in relation to the uniformity of the amplitude of the wobble signal to be reproduced by a reproducing apparatus for the information-recording medium.

According to a third aspect of the present invention, there is provided an information-recording/reproducing apparatus which records or reproduces information on an information-recording medium on which the information is write once or rewritable and in which recording tracks meandering at a predetermined wobble cycle are formed in a spiral form, each of the recording tracks includes a plurality of zones, each of the zones has a principal area formed to have a predetermined wobble phase, and the phases of wobbles formed in the principal areas of predetermined zones disposed adjacently in a circumferential direction are opposite to one another, the information-recording/reproducing apparatus comprising:

a spindle;

a detector which detects a wobble signal from the information-recording medium; and

a control unit which controls a number of revolutions of the spindle on the basis of the detected wobble signal.

In the information-recording/reproducing apparatus according to the third aspect of the present invention, the control unit may include a circuit which multiplies, by an even number, a frequency of the detected wobble signal.

In the information-recording/reproducing apparatus according to the third aspect of the present invention, the control unit may include a circuit which converts the detected wobble signal into a binary signal.

On the recording track of the information-recording medium of the present invention, as described above, the wobble phase is inverted between the principal area in the zone and the area other than the above. Therefore, in the case of the information-recording medium of the present invention, the phase of the wobble signal obtained from the principal area in the zone is opposite to that obtained from the area other than the above. In particular, in the case of the information-recording medium according to the second aspect of the present invention, the wobble phase is appropriately inverted for the zone unit in order to adjust the wobble phase relationship between the tracks disposed adjacently in the radial direction, in which there are such areas that the wobble phases of the principal areas are opposite to one another between the zones adjoining in the circumferential direction. Therefore, in the case of the information-recording medium according to the second aspect, the phase of the wobble signal is not only inverted between the principal area included in the zone and the area other than the above, but the phase of the wobble signal from the principal area is also inverted between the zones. That is, the wobble signal, which is detected from the information-recording medium of the present invention, has either the normal phase or the opposite phase depending on the position. Therefore, any artifice is required when the number of revolutions of the spindle is controlled (subjected to the CLV control) by using the wobble signal as described above. An example thereof is shown in FIG. 7.

FIG. 7 shows an information-recording/reproducing apparatus 70, wherein a multiplier 77, which multiplies, by an even number, the frequency of the wobble signal, is included in a control unit 76 which controls the rotation of a spindle 71. When the wobble signal S1 (signal shown in the upper part in FIG. 7B) after passing through a low pass filter 75 is inputted into the multiplier 77, the wobble signal S1 is multiplied by the even number (multiplied by 2 in the example shown in FIG. 7). As shown in FIG. 7B, the wobble signal from the principal area 101 as well as the wobble signal from the area 102 (area in which the wobble phase is inverted) other than the principal area is converted into the same phase wobble signal S2 (wobble signal with no phase inversion) (signal shown in the middle part in FIG. 7B). That is, even when the wobble signal S1 of any one of the normal phase and the opposite phase is detected, the signal is converted into the same phase wobble signal S2 by the multiplier 77. When a signal S3 (signal shown in the lower part in FIG. 7B), which is obtained by converting the wobble signal S2 into the binary signal by using a binary circuit 78, is inputted into a PLL circuit 79, a predetermined clock signal is generated from the PLL circuit 79 on the basis of the input signal. Thus, it is possible to control (CLV control) the number of revolutions of the spindle 71 by the aid of a motor driver 72.

FIG. 8 shows another example of the information-recording/reproducing apparatus according to the third aspect of the present invention. In the case of the information-recording/reproducing apparatus 80 shown in FIG. 8, a binary circuit 87, which converts the wobble signal S1 into a binary signal, is included in a control unit 86 which controls the rotation of a spindle 71. When the wobble signal S1 (signal shown in the upper part in FIG. 8B) after passing through a low pass filter 75 is inputted into the binary circuit 87, the wobble signal S1 is converted into the binary signal S2′ as shown in the middle part in FIG. 8B. Subsequently, when the edge detection is performed for the binary signal S2′, a binary signal S3′ is obtained as shown in the lower part in FIG. 8B. The binary signal S3′ as shown in the lower part in FIG. 8B is the binary signal having the same cycle as that of the binary signal S3 shown in the lower part in FIG. 7B. Therefore, when the binary signal S3′ as shown in the lower part in FIG. 8B is inputted into a PLL circuit 89, the number of revolutions of the spindle 71 can be controlled by a PLL circuit 89 by the aid of a motor driver 72 in the same manner as in the information-recording/reproducing apparatus shown in FIG. 7.

When the information-recording/reproducing apparatus provided with any one of the control units as shown in FIGS. 7 and 8 is used, it is possible to perform the CLV control on the basis of the wobble signal from the principal area even for the information-recording medium in which the wobble phase is appropriately inverted for the zone unit, as in the information-recording medium according to the second aspect of the present invention, in order to adjust the wobble phase relationship between the tracks disposed adjacently in the radial direction.

According to a fourth aspect of the present invention, there is provided an information-recording/reproducing apparatus which records or reproduces information on an information-recording medium which is formed with information tracks each meandering at a predetermined wobble cycle, the information-recording/reproducing apparatus comprising:

an optical pickup;

a unit which detects a wobble signal from the information-recording medium;

a unit which detects an area in which a wobble phase of a predetermined information track of the information tracks in the information-recording medium is substantially opposite to wobble phases of information tracks disposed adjacently on both sides of the predetermined information track in a radial direction, or an area in which no wobble is formed on the information tracks disposed adjacently on the both sides of the predetermined information track in the radial direction; and

an aberration-correcting unit which corrects a relative inclination of the optical pickup with respect to the information-recording medium on the basis of the wobble signal obtained from the area.

In the information-recording/reproducing apparatus according to the fourth aspect of the present invention, the aberration-correcting unit may determine an amount of correction of the relative inclination of the optical pickup with respect to the information-recording medium by performing calculation with peak values of the wobble signal.

The following principle is affirmed to correct the relative inclination of the optical pickup with respect to the information-recording medium in the information-recording/reproducing apparatus according to the fourth aspect of the present invention. If the optical pickup is relatively inclined with respect to the information-recording medium, when the two peak values (maximum value P1 and minimum value P2) of the wobble signal, which are obtained from the recording track, are added, then the obtained value is offset from zero. Therefore, the relative inclination of the optical pickup with respect to the information-recording medium can be corrected by controlling the inclination of the optical pickup or the information-recording medium so that the added value (P1+P2) of the peak values of the wobble signal is zero by using the aberration-correcting unit.

In particular, in the case of the information-recording medium of the present invention, the average phase difference d (rad) is adjusted to be d>π/2 between the wobble phase in the principal area in the zone and the wobble phase in the recording track area disposed adjacently on the inner circumferential side or the outer circumferential side of the principal area, in relation to all of the recording tracks of the information-recording medium as described above. Therefore, in the case of the information-recording medium of the present invention, as shown in FIGS. 1B and 1C, the wobble phase relationship is in the approximately opposite phase in many areas between the tracks disposed adjacently in the radial direction. In such an area, the wobble signal having the large amplitude is obtained as described above. Therefore, it is possible to correct the relative inclination of the optical pickup with respect to the information-recording medium with ease by the correction method based on the use of the peak values of the wobble signal as described above. In the case of the information-recording/reproducing apparatus of the present invention, an area may be detected, in which no wobble is formed in the tracks disposed adjacently in the radial direction on the both sides of the predetermined track formed with the wobble, and the relative inclination of the optical pickup with respect to the information-recording medium may be corrected on the basis of the wobble signal obtained from the area.

According to a fifth aspect of the present invention, there is provided a phase-adjusting method for recording tracks of an information-recording medium on which information is write once or rewritable and in which the recording tracks meandering at a predetermined wobble cycle T are formed in a spiral form, and each of the recording tracks includes a plurality of zones, the phase-adjusting method comprising:

determining a wobble phase difference d between the recording tracks disposed adjacently in a radial direction; and

adding a predetermined phase to a wobble phase of the predetermined zone included in at lease one recording track of the recording tracks disposed adjacently in the radial direction so that the wobble phase difference d is d>π/2 between the recording tracks disposed adjacently in the radial direction in which the wobble phase difference d would be otherwise d≦λ/2.

According to the information-recording medium of the present invention, the relationship of T>80b is satisfied between the wobble cycle T and the channel bit length b of the recording data. Therefore, even when the partial response system is adopted, and the ETM modulation is used, then the wobble signal and the information recording signal can be completely subjected to the band separation, and it is possible to obtain the wobble signal and the reproduced signal which have satisfactory qualities. Simultaneously, according to the information-recording medium of the present invention, the wobble phase of the predetermined zone is adjusted so that the average phase difference d (rad) is d>π/2 between the wobble phase in the principal area in the zone and the wobble phase in the recording track area disposed adjacently on the inner circumferential side or the outer circumferential side of the principal area, in relation to all of the recording tracks. Therefore, the amplitude fluctuation of the wobble signal, which is generated by the crosstalk, can be suppressed over the substantially entire region of the information-recording medium. Thus, the wobble detection characteristic is stabilized. For example, the waveform as shown in FIG. 3C can be maintained as the wobble signal waveform on the entire recording track of the information-recording medium, and thus the wobble detection characteristic is stabilized.

In the information-recording medium of the present invention, when the wobble phase of the area other than the principal area in the zone is opposite to the wobble phase of the principal area, then the pattern of generation of the wobble signal is such that only two of the normal phase and the opposite phase appear at an identical frequency, and the detection of the wobble signal is easy. When the length of each of the zone is an integral multiple of T/2 (T: wobble cycle) or a multiple obtained by multiplying T/2 by an integer, any remainder of the wobble signal waveform is scarcely generated at the changeover or switchover portion of the zone.

In the information-recording medium of the present invention, when the recording track is constructed so that the wobble phases of the principal areas are opposite to one another between the predetermined zones disposed adjacently in the circumferential direction, the wobble signal from the principal area is in any one of the normal phase and the opposite phase. Therefore, it is easy to detect the wobble signal in all of the zones.

In the information-recording medium of the present invention, when the wobble amplitude of the area having the phase opposite to the wobble phase of the principal area in the zone is allowed to have a magnitude different from that of the wobble amplitude of the principal area, then it is possible to uniformize the degree of the influence of the crosstalk exerted by the adjoining track, and it is possible to provide an identical magnitude for the amplitude of the wobble signal from the principal area and the amplitude of the wobble signal from the area other than the principal area. Therefore, in the case of the information-recording medium constructed as described above, the wobble signal waveform is obtained, in which the amplitude is approximately identical over the entire region of the information-recording medium. For example, it is possible to obtain the wobble signal waveform having the approximately uniform amplitude as shown by a broken line in FIG. 2E by appropriately adjusting the wobble amplitude of the area having the phase opposite to the wobble phase of the principal area in the zone.

The information-recording/reproducing apparatus of the present invention is provided with the control unit which controls the rotation of the spindle on the basis of the wobble signal. Therefore, it is possible to easily perform the CLV control for the medium having the areas in which the wobble phase differs as in the information-recording medium of the present invention as well.

When the circuit, which multiplies, by an even number, the frequency of the wobble signal, is provided in the control unit of the information-recording/reproducing apparatus of the present invention, the signal is converted into the wobble signal having the same phase by the circuit for multiplying the frequency of the wobble signal by the even number, even when any one of the wobble signals of the normal phase and the opposite phase is detected. Therefore, the revolutions of the spindle can be easily subjected to the control (CLV control). Therefore, in the case of the information-recording/reproducing apparatus constructed as described above, for example, as shown in FIG. 1C, the CLV control can be performed with ease for the information-recording medium in which the wobble phase of the predetermined zone is inverted as well.

When the circuit, which converts the wobble signal into the binary signal, is provided in the control unit of the information-recording/reproducing apparatus of the present invention, all of the signals are converted into the binary signals, even when the wobble phase of the principal area is inverted between the zones. Therefore, it is easy to control (CLV control) the number of revolutions of the spindle on the basis of the obtained binary signal. Therefore, in the case of the information-recording/reproducing apparatus constructed as described above, for example, as shown in FIG. 1C, the CLV control can be performed with ease for the information-recording medium in which the wobble phase of the predetermined zone is inverted as well.

The information-recording/reproducing apparatus of the present invention is provided with the aberration-correcting unit for correcting the relative inclination of the optical pickup with respect to the information-recording medium on the basis of the wobble signal. Therefore, even when the optical pickup is relatively inclined with respect to the information-recording medium, information can be recorded and reproduced while correcting the inclination with ease.

The system for expressing the address with the wobble itself is not the essential feature of the present invention, and hence any detailed explanation thereof is omitted. However, it is an essential requirement for the information-recording medium of the present invention that the wobble of the principal area is constructed to have the same phase in the zone. For example, the ADIP system, which is introduced in ECMA-349, is effective.

### BRIEF DESCRIPTION OF THE DRAWINGS

FIG. 1 shows the wobble phase relationship between tracks disposed adjacently in the radial direction of the information-recording medium of the present invention, wherein FIG. 1A shows the wobble phase relationship before adjusting the wobble phase of the recording tracks, FIG. 1B shows the wobble phase relationship when the wobble phase of the recording tracks is adjusted by adjusting the length of the predetermined zone, and FIG. 1C shows the wobble phase relationship when the wobble phase of the recording tracks is adjusted by inverting the phase of the predetermined zone.

FIGS. 2A to 2E show the relationship between the wobble phase and the wobble signal.

FIGS. 3A to 3E show the wobble structure and the data format of an information-recording medium manufactured in a first embodiment.

FIG. 4 shows a schematic structure of the wobble disposed in the vicinity of the zone boundary of the information-recording medium manufactured in the first embodiment.

FIG. 5 shows the schematic wobble structure of an information-recording medium manufactured in a second embodiment.

FIGS. 6A to 6C show the data format and the wobble structure of an information-recording medium manufactured in a third embodiment.

FIG. 7A shows a schematic arrangement of an information-recording/reproducing apparatus used in a fourth embodiment, and FIG. 7B explains the principle of the rotation control of a spindle.

FIG. 8A shows a schematic arrangement of an information-recording/reproducing apparatus used in a fifth embodiment, and FIG. 8B explains the principle of the rotation control of a spindle.

FIG. 9A shows a schematic arrangement of an information-recording/reproducing apparatus used in a sixth embodiment, and FIG. 9B explains the principle of the correction of the aberration.

### DESCRIPTION OF THE PREFERRED EMBODIMENTS

The information-recording medium and the information-recording/reproducing apparatus according to the present invention will be specifically explained below with reference to the drawings. However, the present invention is not limited thereto.

### First Embodiment

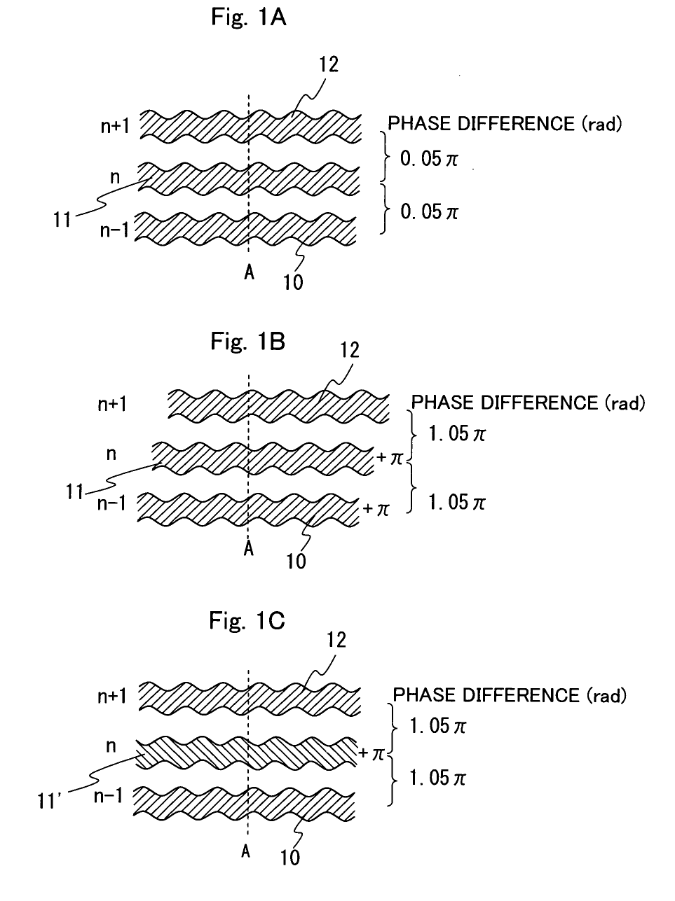

In a first embodiment, an information-recording medium was manufactured, in which the wobble phase of the recording tracks was adjusted so that the wobble phase difference was larger than π/2 between the tracks disposed adjacently in the radial direction over the substantially entire region of the information-recording medium by adjusting the length of a predetermined zone of a plurality of zones for constructing the recording tracks as shown in FIG. 1B.

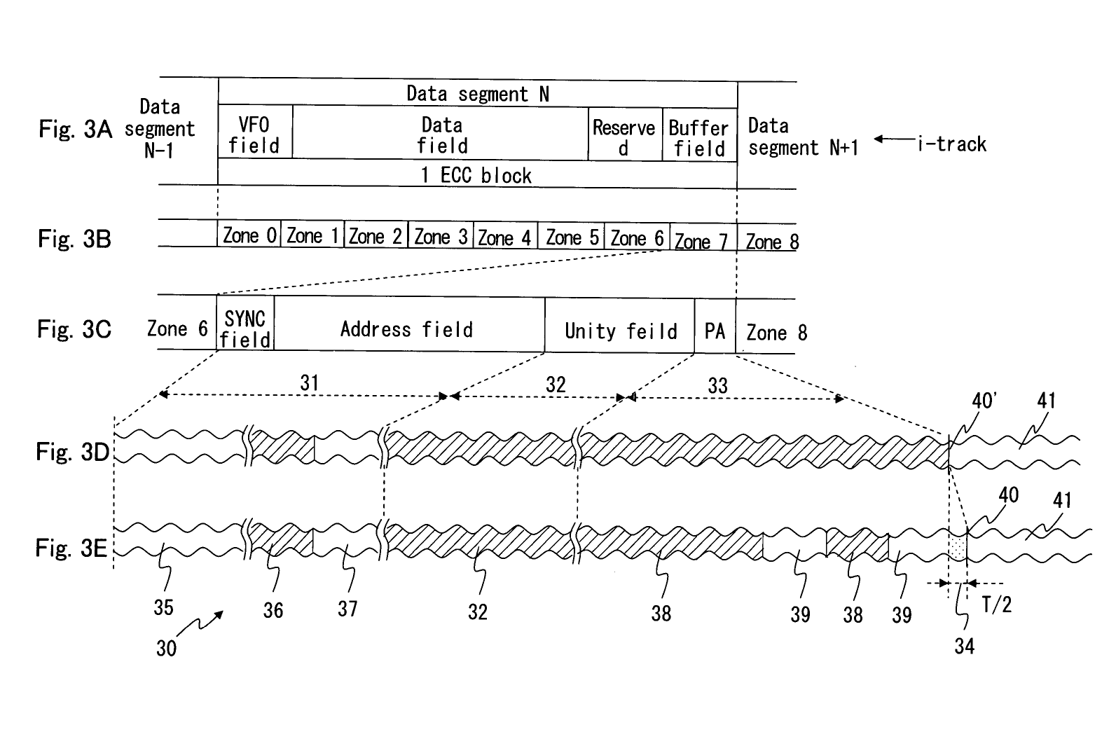

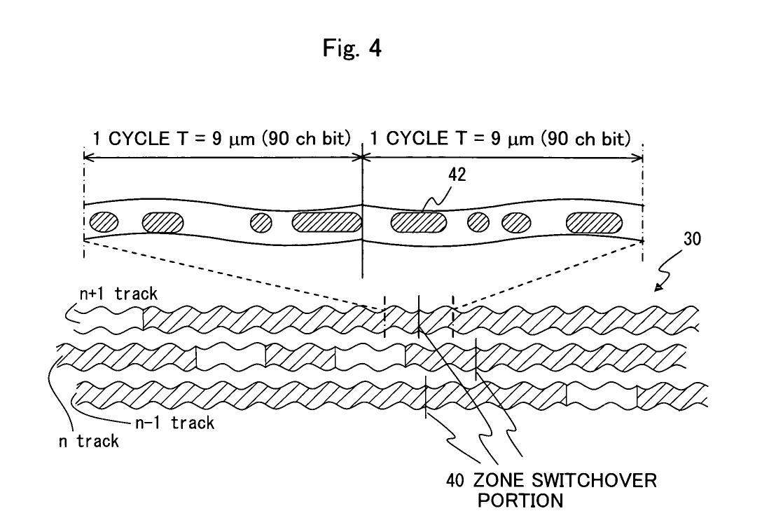

FIGS. 3 and 4 schematically show a data format and a wobble structure of an ith recording track (hereinafter simply referred to as “track i”) of the information-recording medium of the first embodiment. FIG. 3 shows the data format of the track i and the wobble structure of a zone for constructing the track i. FIG. 4 shows a magnified view illustrating zone switchover portions. FIG. 3D shows a wobble structure of the zone before adjusting the wobble phase for the purpose of comparison. FIG. 3E shows a wobble structure of the zone of this embodiment (wobble structure after adjusting the wobble phase). In this embodiment, it is assumed that the average phase difference d is d≈0 or 2π (approximately the same phase) between the wobble phase of the principal area of the track i and the wobble phases of the areas of the tracks i+1 and i−1 (not shown) disposed adjacently on the outer circumferential side and the inner circumferential side of the area, when the track i is formed to have the wobble structure shown in FIG. 3D (without adjusting the wobble phase).

In the case of the information-recording medium 30 of this embodiment, as shown in FIG. 4, the recording tracks, which meandered at a wobble cycle T=9 μm, were formed in a spiral form. In this embodiment, the recording data 42 (recording mark) shown in FIG. 4 had a channel bit length b of b=0.1 μm. That is, the information-recording medium 30 of this embodiment was manufactured as the information-recording medium 30 to give the wobble cycle T=90b.

As shown in FIG. 3A, the recording track of the information-recording medium 30 of this embodiment was composed of a plurality of data segments as shown in FIG. 3A. In this embodiment, each of the data segments was formed to have one ECC block unit length. Further, in this embodiment, each of the data segments was composed of eight zones (zones 0 to 7) as shown in FIG. 3B. The length of one zone was designed to be an integral multiple of T/2 (T: wobble cycle). Further, in this embodiment, for example, the zone 7 shown in FIG. 3B comprises a field 31 principally including the address information (including SYNC field as well), a unity area 32, and a PA field 33. Solid line portions 40′ and 40 shown in FIGS. 3D and 3E indicate the zone switchover portions.

The unity field 32 is formed with the wobble which occupies the greater part of the zone 7 and which is formed to have a predetermined wobble phase. In the unity field 32, the wobble phase is not inverted, and the wobble of the identical phase is formed.

As shown in FIG. 3E, those formed in the field 31 including the address information include a wobble area 36 having the same wobble phase as that of the unity field 32, and wobble areas 35, 37 having the phase opposite thereto. The address information is recorded in the wobble area 37 in the field 31. The address information is recorded by inverting the phase of the wobble with respect to the wobble area 36. The address expression system of this embodiment conforms to the address expression described, for example, in ECMA-349. Specifically, the address information is recorded by combining the same phase wobble having the same cycle and the opposite phase wobble as compared with the wobble of the unity field 32.

As shown in FIG. 3E, identifiers 39, which indicate the boundary of the zone 7, are provided in the vicinity of the boundary area disposed on the side of the zone 41 of the data segment N+1 in the PA field 33. As shown in FIG. 3E, the identifiers 39 were recorded by inverting the wobble phase with respect to the area 38 in the PA field having the same phase as that of the unity field 32.

In the information-recording medium 30 of this embodiment, the wobble phase is the same in the unity field 32, the area 36 in the field 31 including the address information, and the wobble area 38 in the PA field 33. The wobble phases of these areas or fields constitute the wobble phase which occupies the greater part of the zone 7. Therefore, these areas or the fields constitute the principal area in the zone of the information-recording medium of this embodiment. The wobble areas 35, 37, 39, which indicate, for example, the identifier and the address information in the relationship of the opposite phase with respect to the wobble phase of the principal area, are not included in the principal area.

In the information-recording medium 30 of this embodiment, as shown in FIG. 3E, a wobble area 34 corresponding to a half cycle (length: T/2) was added to the end of the PA field 33 on the side of the zone 41 of the data segment N+1. In a viewpoint of the phase, this means the fact that the phase of π (rad) is added to the wobble phase of the zone 7. The wobble phase of the added wobble area 34 may be either the same phase or the opposite phase with respect to the wobble phase of the principal area. In this embodiment, as shown in FIG. 3E, the wobble phase of the wobble area 34 was opposite to the phase of the principal area in conformity with the wobble phase of the wobble area 39 located at the aftermost end of the PA field 33 (on the side of the area 34).

As shown in FIG. 3E, when the zone length of the zone 7 is lengthened by the amount of the half cycle (T/2) of the wobble cycle T, the wobble phase of the track i+1 disposed on the outer circumferential side of the track i is relatively deviated by the amount of the half cycle T/2 (π in the phase) with respect to the track i. Therefore, the wobble phase of the principal area of the zone 7 is approximately opposite to the wobble phase of the area of the track i+1 disposed adjacently on the outer circumferential side thereof.

In this embodiment, the average phase difference d of the wobbles was determined between the recording tracks disposed adjacently in the radial direction, and the wobble phase was adjusted in accordance with the method as described above between the recording tracks in which the average phase difference d is d<π/2. The phase adjustment was performed for all of the recording tracks of the information-recording medium 30. As a result, in the information-recording medium 30 of this embodiment, the average phase difference d of the wobbles of the principal areas was larger than π/2 between the recording tracks disposed adjacently in the radial direction over the entire region of the information-recording medium. Therefore, in the information-recording medium of this embodiment, the amplitude of the wobble signal obtained from the principal area is increased, and the amplitude of the wobble signal from the principal area has approximately the same magnitude over the entire region of the information-recording medium. Therefore, it is possible to suppress the amplitude fluctuation of the wobble signal as well.

A wobble having the same phase as that of the principal area may be formed over one round on the recording track disposed at the innermost circumference.

### Second Embodiment

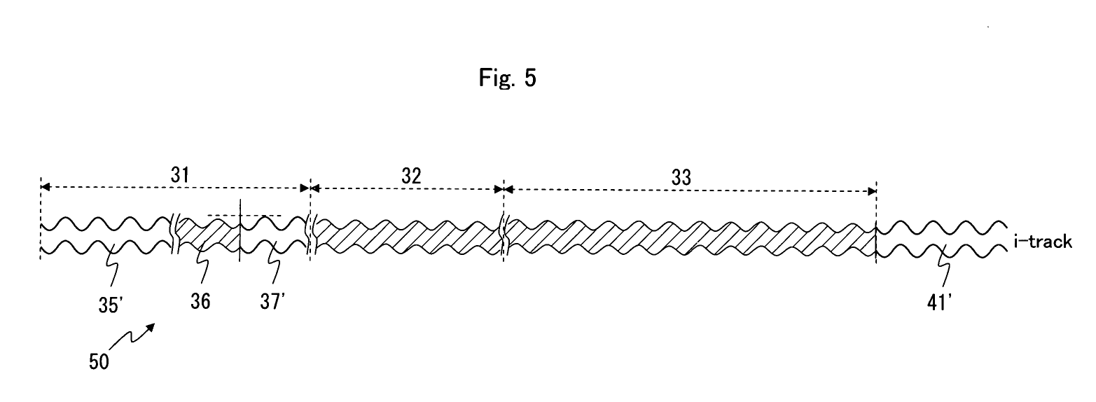

FIG. 5 shows a wobble structure of a predetermined zone of a track i of an information-recording medium according to a second embodiment. As shown in FIG. 5, the zone of the information-recording medium 50 of this embodiment has the same wobble structure as that of the zone of the information-recording medium of the first embodiment, which comprises a field 31 including the address information, a unity field 32, and a PA field 33. In the information-recording medium of this embodiment, the wobble area 36 in the field 31, the unity field 32, and the PA field are formed to have the same wobble phase, and they reside in the wobble area formed to have the predetermined wobble phase while occupying the greater part of the zone. Therefore, these areas or fields constitute the principal area.

As shown in FIG. 5, in the information-recording medium 50 of this embodiment, the wobble amplitudes of the wobble area 35′ and the wobble area 37′ (area recorded with the address information) in the field 31 having the phase opposite to the wobble phase of the principal area were larger than the wobble amplitude of the principal area. The wobble structure was the same as or equivalent to that of the first embodiment except that the magnitude of the wobble amplitude of the area (area having the wobble phase opposite to that of the principal area) other than the principal area was changed.

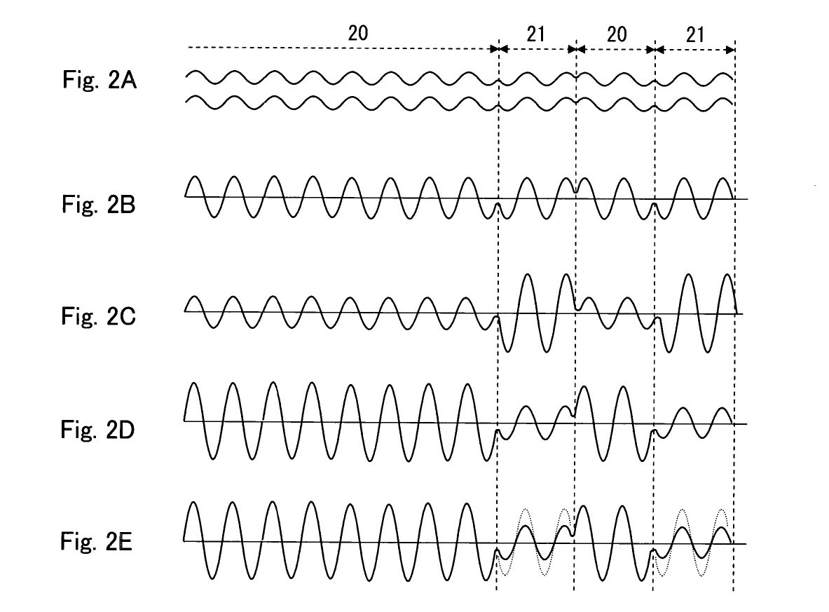

In the information-recording medium of the present invention, the average phase difference d of the wobble is adjusted to be d>π/2 (rad) between the principal area in the zone and the area disposed adjacently in the radial direction with respect to the concerning area as described above. However, the wobble phase is opposite to the wobble phase of the principal area in the area other than the principal area. Therefore, the average phase difference d′ of the wobble is d′<π/2 (rad) between the area other than the principal area and the area disposed adjacently in the radial direction with respect to the area. Therefore, the degree of the influence of the crosstalk exerted from the adjoining track differs between the principal area and the area other than the principal area. The amplitudes of the wobble signals detected from these areas are also different from each other. Specifically, as shown in the signal waveform indicated by the solid line in FIG. 2E, the amplitude of the wobble signal from the area (area 21 in FIG. 2) other than the principal area is smaller than the amplitude of the wobble signal from the principal area (area 20 in FIG. 2).

Therefore, in order to obtain the wobble signal waveform having approximately the same amplitude over the entire region of the information-recording medium, it is preferable that the wobble amplitude of the area other than the principal area is changed with respect to the wobble amplitude of the principal area in each of the zones. In this embodiment, as shown in FIG. 5, the wobble amplitude of the area other than the principal area, for example, the wobble area 37′ was made larger than the wobble amplitude of the principal area, for example, the wobble area 36 and the unity field 32. When the wobble amplitude of the area other than the principal area is appropriately adjusted as described above, the wobble signal waveform having the approximately uniform amplitude is obtained as shown by the broken line in FIG. 2E. In this case, it is possible to improve the uniformity of the amplitude of the wobble signal waveform reproduced by the reproducing apparatus for the information-recording medium.

### Third Embodiment

In a third embodiment, an information-recording medium was manufactured, in which the wobble phase of the recording track was adjusted so that the wobble phase difference was larger than π/2 between the tracks disposed adjacently in the radial direction over the substantially entire region of the information-recording medium by inverting the phase for the zone unit of at least one zone for constructing the recording track as shown in FIG. 1C. The information-recording medium of this embodiment was designed so that the length of one zone was an integral multiple of T/2 (T: wobble cycle).

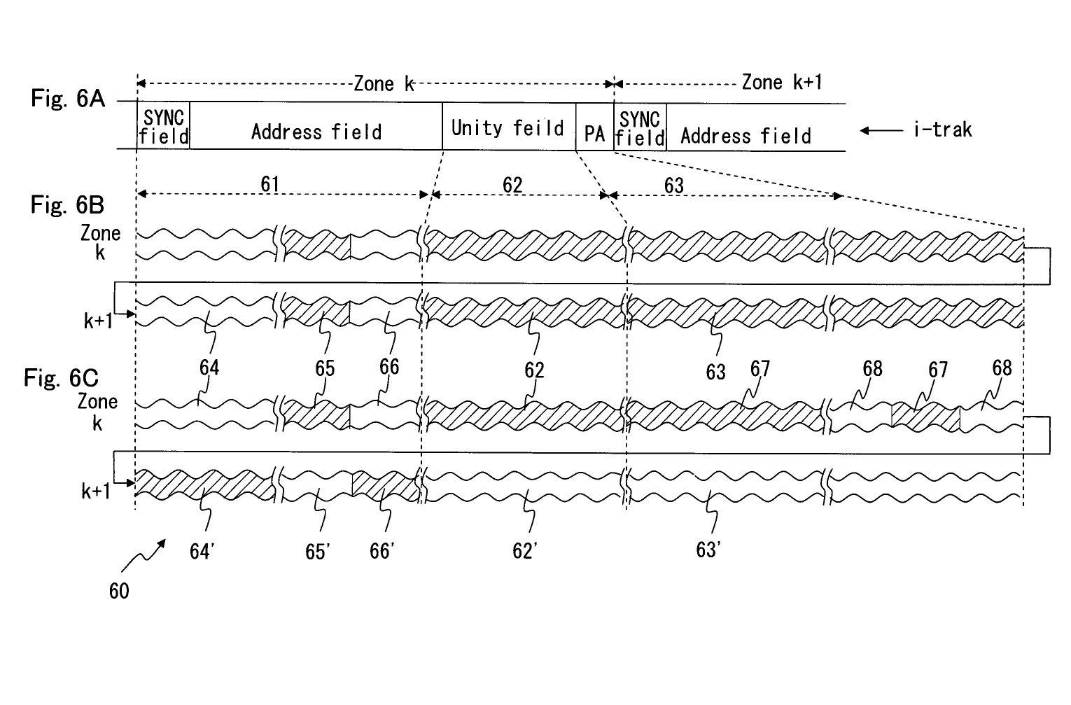

FIG. 6 schematically shows the wobble structure and the data format of the zones k and k+1 of an ith recording track (hereinafter simply referred to as “track i”) of the information-recording medium of the third embodiment. FIG. 6B shows the wobble structure of the zones before adjusting the wobble phase for the purpose of comparison. FIG. 6C shows the wobble structure of the zones of this embodiment (wobble structure after adjusting the wobble phase). In FIGS. 6B and 6C, the wobble structure in the upper part of the drawing shows the wobble structure of the zone k, and the lower part of the drawing shows the wobble structure of the zone k+1 disposed adjacently to the zone k in the circumferential direction. It is assumed that when the track i is constructed with the wobble structure shown in FIG. 6B (when the wobble phase is not adjusted), the average phase difference d is d≈0 or 2π (approximately the same phase) between the wobble phase of the principal area of the zone k+1 of the track i (area 65, unity field 62, and PA field 63) and the wobble phase of each of the areas of the tracks i+1 and i−1 (not shown) disposed adjacently on the outer circumferential side or the inner circumferential side of the concerning area.

When the recording track is not subjected to the phase adjustment as described above, the wobble phase of the principal area of the zone k+1 is approximately the same as the wobble phase of each of the areas of the track i+1 and i−1 (not shown) disposed adjacently on the outer circumferential side or the inner circumferential side of the concerning area. Therefore, in the case of the information-recording medium 60 of this embodiment, the wobble phase of the recording track was adjusted so that the wobble phase of the principal area of the zone k+1 was approximately opposite to the wobble phase of each of the areas of the track i+1 and i−1 (not shown) disposed adjacently on the outer circumferential side or the inner circumferential side of the concerning area by inverting the wobble phase of the zone k+1 for the zone unit as shown in FIG. 6C. As viewed from a viewpoint of the phase, the phase of π (rad) is added to the wobble phase of the zone k+1 in this embodiment. Therefore, the wobble phase of the principal area of the zone k+1 (area 65′, unity field 62′, and PA field 63′) after the inversion of the phase is in the opposite relationship with respect to the wobble phase of the principal area of the zone k (area 65, unity field 62, and area 67).

In this embodiment, as shown in FIG. 6C, identifiers 68, which indicate the fact that the phase of the zone k+1 is inverted for the zone unit, are provided in the vicinity of the boundary on the side of the zone k+1 in the PA field 63 of the zone k. The identifiers 68 were formed by inverting the wobble phase.

The information-recording medium 60 of this embodiment was constructed in the same manner as in the first embodiment except that the wobble phase of the principal area was in the approximately opposite phase relationship with respect to the wobble phase of the area of the track disposed adjacently on the outer circumferential side or the inner circumferential side of the concerning area by inverting the wobble phase of the predetermined zone.

In this embodiment, the average phase difference d of the wobble was determined between the recording tracks disposed adjacently in the radial direction. The wobble phase was adjusted in accordance with the method as described above between the recording tracks in which the average phase difference d was d<π/2. The phase adjustment was performed for all of the recording tracks of the information-recording medium 60. As a result, in the information-recording medium 60 of this embodiment, the average phase difference d of the wobble of the principal area was larger than π/2 between the recording tracks disposed adjacently in the radial direction over the entire region of the information-recording medium. Therefore, in the information-recording medium of this embodiment, the amplitude of the wobble signal obtained from the principal area is increased, and the amplitude of the wobble signal obtained from the principal area has approximately the same magnitude over the entire region of the information-recording medium. Therefore, it is also possible to suppress the amplitude fluctuation of the wobble signal.

The method for adjusting the length of the predetermined zone has been explained in the first embodiment, and the method for inverting the phase of the predetermined zone for the zone unit has been explained in the third embodiment. However, the present invention is not limited thereto. The method for adjusting the length of the predetermined zone (method of the first embodiment) and the method for inverting the phase of the predetermined zone for the zone unit (method of the third embodiment) may be appropriately combined to adjust the wobble phase difference between the tracks disposed adjacently in the radial direction.

### Fourth Embodiment

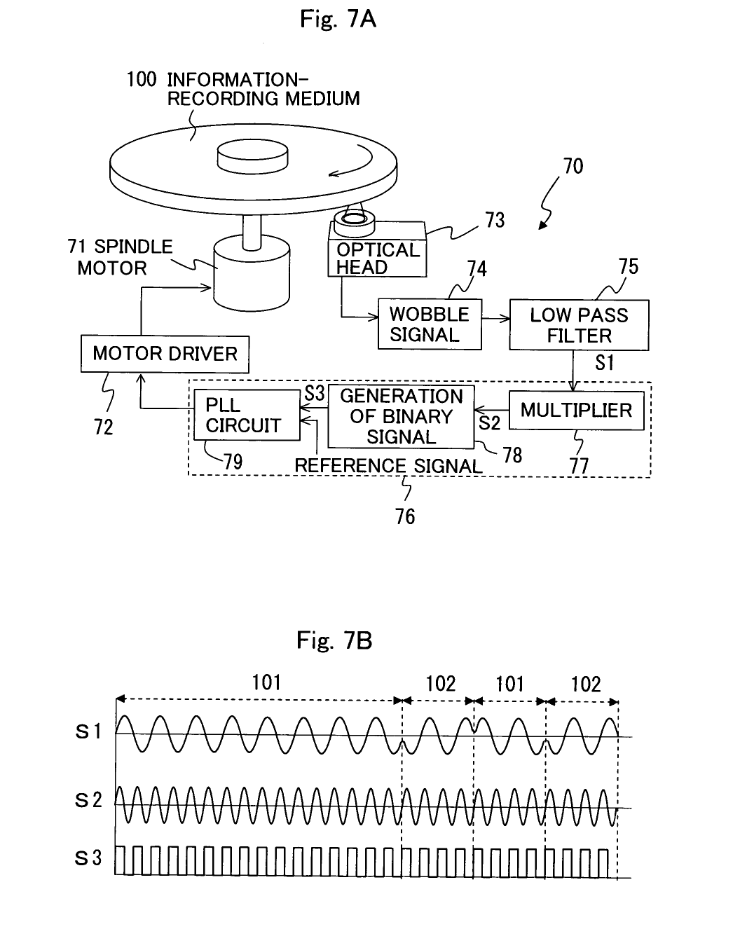

In a fourth embodiment, an explanation will be made about an information-recording/reproducing apparatus for recording or reproducing information on each of the information-recording media of the first to third embodiments. In the case of the information-recording medium of the present invention, the wobble phase is inverted depending on the position in the information-recording medium as described above. Therefore, the detected wobble signal also has either the normal phase or the opposite phase depending on the position. Therefore, any artifice is required when the number of revolutions of the spindle is controlled (subjected to the CLV control) by using the wobble signal as described above. FIG. 7 shows a schematic arrangement of the information-recording/reproducing apparatus of this embodiment.

As shown in FIG. 7A, the information-recording/reproducing apparatus 70 of this embodiment includes a spindle 71 which rotates the information-recording medium 100 of any one of the first to third embodiments, a motor driver 72 which controls the spindle 71, an optical head 73 which radiates the light beam onto the information-recording medium 100, a wobble signal-detecting circuit 74, a low pass filter 75, and a control unit 76 which controls the number of revolutions of the spindle 71. FIG. 7 shows only the arrangement of the part for controlling the spindle 71 on the basis of the wobble signal. However, the arrangement other than the above is constructed in the same manner as in the conventional information-recording/reproducing apparatus.

As shown in FIG. 7A, the control unit 76 of the information-recording/reproducing apparatus 70 of this embodiment includes a multiplier 77, a binary circuit 78, and a PLL circuit 79.

In the information-recording/reproducing apparatus 70 of this embodiment, the linear velocity of the information-recording medium was 5 m/sec when information was recorded or reproduced. The wobble signal is a signal of about 560 kHz, because the wobble cycle T of the recording track is T=9 μm (not less than 80 times the channel bit length b=0.1 μm). On the other hand, the information reproduced signal subjected to the ETM modulation is a signal having a frequency of not less than 2.5 MHz, because the repeating cycle of the longest mark of the recording data is about 20b=20×0.1 μm=2 μm. Therefore, in the case of the information-recording/reproducing apparatus 70 of this embodiment, the cutoff frequency of the low pass filter 75 was set to about 1.2 MHz in order to effect the complete band separation for the wobble signal and the information reproduced signal by using the low pass filter 75. When the cutoff frequency of the low pass filter 75 is set to about 1.2 MHz, the wobble signal having the frequency of 560 kHz which is not more than a half of the cutoff frequency can be completely separated from the ETM-modulated information reproduced signal having the frequency which is not less than twice the frequency of the wobble signal. It is possible to perform the detection without deteriorating the quality of the wobble signal.

Next, an explanation will be made about the operation of the information-recording/reproducing apparatus of this embodiment. At first, the light beam is radiated from the optical head 73 onto a predetermined area of the information-recording medium 100. Subsequently, the wobble signal is detected by the wobble-detecting circuit 74 from the reflected light beam from the information-recording medium 100 obtained by the aid of the optical head 73. Any noise such as the information reproduced signal is also included in the wobble signal detected by the wobble-detecting circuit 74.

Subsequently, when the detected wobble signal is allowed to pass through the low pass filter 75, then the wobble signal and the information reproduced signal are completely separated from each other, and the high quality wobble signal S1 is obtained. In this procedure, a wobble signal waveform as shown in the upper part of FIG. 7B is obtained. In the signal waveform shown in the upper part of FIG. 7B, the signal in an area 101 is the wobble signal which is obtained from the principal area, and the signal in an area 102 is the wobble signal which is obtained from the area other than the principal area, for example, from the area such as a part of the address field in which the wobble phase is the opposite phase.

Subsequently, the wobble signal S1, which is obtained after passing through the low pass filter 75, is inputted into the multiplier 77. The wobble signal S1 is doubled by the multiplier 77. As shown in the middle part in FIG. 7B, the wobble signal detected from the area 102 (opposite phase) in which the wobble phase is inverted as well as the wobble signal detected from the area 101 (normal phase) in which the wobble phase is not inverted is converted into the same phase wobble signal S2. That is, in the case of the information-recording/reproducing apparatus 70 of this embodiment, even when the wobble signal S1 having any one of the normal phase and the opposite phase is detected, the wobble signal S1 is converted by the multiplier 77 into the same phase wobble signal S2.

Subsequently, the wobble signal S2 is subjected to the binary signal generation by the binary circuit 78 to generate the binary signal S3 as shown in the lower part of FIG. 7B. Subsequently, the binary signal S3 and the reference signal are inputted into the PLL circuit 79. A predetermined clock signal is generated by the PLL circuit 79 on the basis of the input signals. The predetermined clock signal, which is generated by the PLL circuit 79, is used control the number of revolutions of the spindle 71 by the aid of the motor driver 72.

As described above, in the case of the information-recording/reproducing apparatus 70 of this embodiment, the wobble signal S1 having any one of the normal phase and the opposite phase can be converted into the same phase wobble signal S2 by the multiplier 77. Therefore, when the same phase wobble signal S2 is used, it is possible to perform the CLV control with ease. This embodiment is illustrative of the case of the use of the multiplier which doubles the frequency of the wobble signal. However, the present invention is not limited thereto. The same effect as that described above is obtained with any multiplier provided that the multiplier multiplies the frequency by an even number.

The information-recording/reproducing apparatus of this embodiment is especially effective for the information-recording medium in which the predetermined zone is subjected to the phase inversion for the zone unit, for example, as in the information-recording medium described in the third embodiment.

### Fifth Embodiment

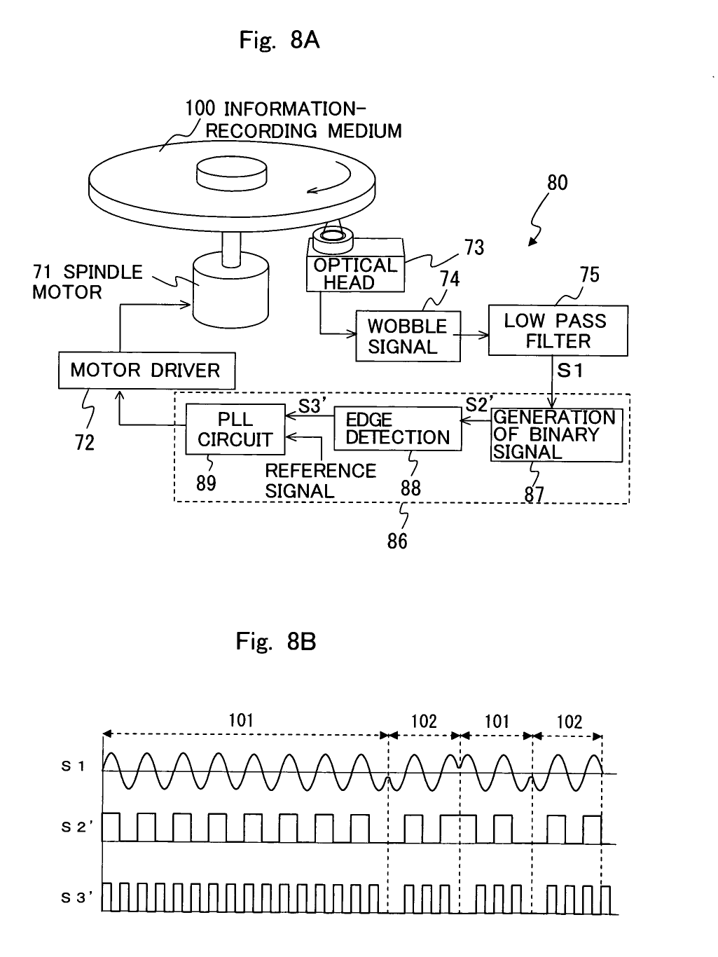

In a fifth embodiment, an explanation will be made about another exemplary information-recording/reproducing apparatus for recording or reproducing information on each of the information-recording media of the first to third embodiments. FIG. 8 shows a schematic arrangement of the information-recording/reproducing apparatus of this embodiment.

As shown in FIG. 8A, the information-recording/reproducing apparatus 80 of this embodiment includes a spindle 71 which rotates the information-recording medium 100 of any one of the first to third embodiments, a motor driver 72 which controls the spindle 71, an optical head 73 which radiates the light beam onto the information-recording medium 100, a wobble signal-detecting circuit 74, a low pass filter 75, and a control unit 86 which controls the number of revolutions of the spindle 71. FIG. 8 shows only the arrangement of the part for controlling the spindle 71 on the basis of the wobble signal. However, the arrangement other than the above is constructed in the same manner as in the conventional information-recording/reproducing apparatus.

As shown in FIG. 8A, the control unit 86 of the information-recording/reproducing apparatus 80 of this embodiment includes a binary circuit 87, an edge-detecting circuit 88, and a PLL circuit 89. The information-recording/reproducing apparatus of this embodiment was constructed in the same manner as the information-recording/reproducing apparatus of the fourth embodiment except that the arrangement of the control unit 86 was changed.

Next, an explanation will be made about the operation of the information-recording/reproducing apparatus of this embodiment. At first, the light beam is radiated from the optical head 73 onto a predetermined area of the information-recording medium 100. Subsequently, the wobble signal is detected by the wobble-detecting circuit 74 from the reflected light beam from the information-recording medium 100 obtained by the aid of the optical head 73. Any noise such as the information reproduced signal is also included in the wobble signal detected by the wobble-detecting circuit 74.

Subsequently, when the detected wobble signal is allowed to pass through the low pass filter 75, then the wobble signal and the information reproduced signal are completely separated from each other, and the high quality wobble signal S1 is obtained. In this procedure, a wobble signal waveform as shown in the upper part of FIG. 8B is obtained. In the signal waveform shown in the upper part of FIG. 8B, the signal in an area 101 is the wobble signal which is obtained from the principal area, and the signal in an area 102 is the wobble signal which is obtained from the area other than the principal area, for example, from the area such as a part of the address field in which the wobble phase is the opposite phase.

Subsequently, the wobble signal S1, which is obtained after passing through the low pass filter 75, is inputted into the binary circuit 87. The wobble signal S1 is subjected to the binary signal generation by the binary circuit 87, which is converted into a binary signal S2′ as shown in the middle part of FIG. 8B. Subsequently, when the binary signal S2′ is inputted into the edge-detecting circuit 88 to perform the edge detection, a binary signal S3′ is generated as shown in the lower part of FIG. 8B. The binary signal S3′ is the signal having the same cycle as that of the binary signal S3 shown in the lower part of FIG. 7B as explained in the fourth embodiment. Therefore, when the binary signal S3′ and the reference signal are inputted into the PLL circuit 89, a predetermined clock signal is generated by the PLL circuit 89 in the same manner as in the fourth embodiment. The number of revolutions of the spindle 71 can be PLL-controlled by the aid of the motor driver 72 in the same manner as in the fourth embodiment on the basis of the clock signal generated by the PLL circuit 89. Therefore, in the case of the information-recording/reproducing apparatus 80 provided with the control unit 86 constructed as shown in FIG. 8, the wobble signal having any one of the normal phase and the opposite phase can be subjected to the CLV control with ease in the same manner as in the fourth embodiment.

The information-recording/reproducing apparatus of this embodiment is especially effective for the information-recording medium in which the predetermined zone is subjected to the phase inversion for the zone unit, for example, as in the information-recording medium described in the third embodiment.

### Sixth Embodiment

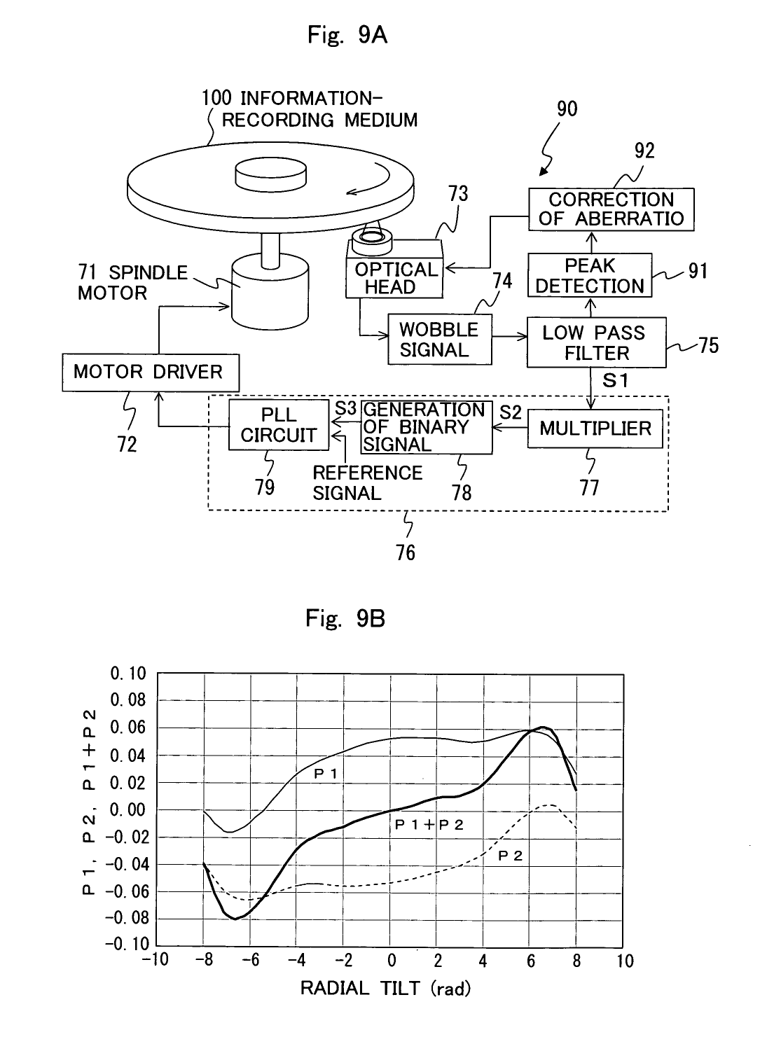

In a sixth embodiment, an explanation will be made about still another exemplary information-recording/reproducing apparatus for recording or reproducing information while correcting the relative inclination between the optical head and each of the information-recording media of the first to third embodiments. FIG. 9 shows a schematic arrangement of the information-recording/reproducing apparatus of this embodiment.

As shown in FIG. 9A, the information-recording/reproducing apparatus 90 of this embodiment includes a spindle 71 which rotates the information-recording medium 100 of any one of the first to third embodiments, a motor driver 72 which controls the spindle 71, an optical head 73 which radiates the light beam onto the information-recording medium 100, a wobble signal-detecting circuit 74, a low pass filter 75, a control unit 76 which controls the number of revolutions of the spindle 71, a peak-detecting circuit 91 which detects the peak values of the wobble signal (maximum value P1 and minimum value P2), and an aberration-correcting circuit 92 which corrects the inclination of the optical head 73 on the basis of the detected peak values of the wobble signal. FIG. 9 shows only the arrangement of the part for controlling the spindle 71 and the arrangement of the part for correcting the aberration of the optical head 73 on the basis of the wobble signal. However, the arrangement other than the above is constructed in the same manner as in the conventional information-recording/reproducing apparatus. That is, the information-recording/reproducing apparatus 90 of this embodiment is such an apparatus that the peak-detecting circuit 91 for correcting the relative inclination between the information-recording medium 100 and the optical head 73 and the aberration-correcting circuit 92 are added to the information-recording/reproducing apparatus of the fourth embodiment. Therefore, any explanation about the constitutive circuit concerning those other than the peak-detecting circuit 91 and the aberration-correcting circuit 92 will be omitted in this embodiment.

The peak-detecting circuit 91 not only detects the peak values (maximum value P1 and minimum value P2) of the high quality wobble signal S1 having passed through the low pass filter 75 as described later on, but the peak-detecting circuit 91 also compares the ratio for the wobble amplitude of the principal area and the wobble amplitude of the area other than the principal area to distinguish whether or not the wobble phase of the area of the recording track in which the wobble signal S1 is detected is approximately opposite to the wobble phase of each of the areas disposed adjacently on the both sides of the area in the radial direction in relation to the concerning area. In the case of the information-recording medium of the present invention, the wobble phases are approximately opposite phases among all of the adjoining tracks depending on the adjustment of the wobble phase. Therefore, in such a situation, it is also allowable that the area of the track, in which the wobble signal S1 is detected as described above, is not distinguished. The aberration-correcting circuit 92 adds the peak values P1 and P2 of the detected wobble signal S1 to determine the aberration correction amount of the optical head 73 on the basis of the added value P1+P2.

The following principle is affirmed for the method for correcting the relative inclination of the optical head 73 with respect to the information-recording medium 100 in the information-recording/reproducing apparatus 90 of this embodiment. When the optical head 73 is relatively inclined with respect to the information-recording medium 100, the added value (P1+P2) of the two peak values (maximum value P1 and minimum value P2) of the wobble signal obtained from the recording track is offset from zero. FIG. 9B shows this situation. The characteristics shown in FIG. 9B represent the changes of the peak values P1 and P2 of the wobble signal with respect to the amount of inclination and the added value P1+P2 of the peak values when the information-recording medium 100 and the optical head 73 are relatively inclined in the radial direction. The wobble signal, which provides the characteristics shown in FIG. 9B, is the signal detected from the area in which the wobble phase relationship resides in the approximately opposite phase between the tracks disposed adjacently in the radial direction.

As clarified from FIG. 9B, when the radial tilt occurs between the information-recording medium 100 and the optical head 73, the added value P1+P2 of the peak values of the wobble signal is offset from zero by a predetermined amount depending on the amount of the inclination. Therefore, the relative inclination between the optical head 73 and the information-recording medium 100 can be corrected by adjusting the inclination of the optical head 73 so that the added value P1+P2 of the wobble signal is zero.

Next, an explanation will be made about the operation of the information-recording/reproducing apparatus 90 of this embodiment. However, the method for controlling the number of revolutions of the spindle 71 is the same as that described in the fourth embodiment. Therefore, an explanation will now be made about the operation of the optical head 73 to correct the aberration.

At first, the high quality wobble signal S1, which has passed through the low pass filter 75, is inputted into the peak-detecting circuit 91. Subsequently, the peak-detecting circuit 91 judges whether or not the wobble phase of the area of the track in which the wobble signal S1 is detected is approximately opposite to the wobble phases of the areas disposed adjacently on the both sides in the radial direction in relation to the concerning area. When the area of the track, in which the wobble signal S1 is detected, is the area as described above, the peak values (maximum value P1 and minimum value P2) of the wobble signal S1 are detected. Subsequently, the peak values (maximum value P1 and minimum value P2) of the detected wobble signal S1 are inputted into the aberration-correcting circuit 92. The aberration-correcting circuit 92 adds the peak values (maximum value P1 and minimum value P2) of the detected wobble signal S1 to determine the amount of correction of the aberration for the optical head 73. Subsequently, a signal, which relates to the amount of correction of the aberration determined by the aberration-correcting circuit 92, is inputted into the head 73 to adjust the relative inclination between the optical head 73 and the information-recording medium 100.

When the information-recording/reproducing apparatus 90 of this embodiment is used, it is possible to perform the CLV control while correcting the relative inclination between the optical head and the information-recording medium for the information-recording medium of the present invention described in each of the first to third embodiments. It is possible to record and reproduce information more correctly on the information-recording media of the present invention described in each of the first to third embodiments.

The information-recording/reproducing apparatus of the sixth embodiment has been explained as such an example that the aberration is corrected by using the wobble signal detected from the area in which the wobble phase relationship resides in the approximately opposite phase between the tracks disposed adjacently in the radial direction. However, the present invention is not limited thereto. The wobble signal may be detected from such an area that the tracks, which are disposed adjacently on the both sides in the radial direction of the predetermined track formed with the wobble, are the tracks in which no wobble is formed, and the relative inclination of the optical head with respect to the information-recording medium may be corrected on the basis of the wobble signal.

The sixth embodiment has been explained as such an example that the inclination of the optical head is adjusted to correct the relative inclination of the optical head with respect to the information-recording medium. However, the present invention is not limited thereto. For example, the information-recording medium may be held by using an aberration-correcting plate, and the inclination of the aberration-correcting plate, i.e., the inclination of the information-recording medium may be adjusted on the basis of the added value P1+P2 of the wobble signal.

As described above, the information-recording medium of the present invention is formed such that the wobble cycle T is sufficiently longer than the channel bit length b of the recording data. Specifically, the wobble, which satisfies T>80b (wobble to be used when the partial response system is adapted and the ETM modulation is used), is formed on the recording track. Further, the average phase difference of the wobble is larger than π/2 between the tracks disposed adjacently in the radial direction. Therefore, the wobble signal and the information recording signal can be completely subjected to the band separation. It is possible to obtain the high quality wobble signal and the high quality reproduced signal, and the amplitude fluctuation of the wobble signal, which would be otherwise caused by the crosstalk, can be reduced over the entire information-recording medium. Therefore, the information-recording medium of the present invention is most suitable for the write-once type or the rewritable type HD DVD. Further, the information-recording/reproducing apparatus of the present invention is also most suitable as the recording and reproducing apparatus for the write-once type or the rewritable type HD DVD.

What is claimed is:

1. An information-recording medium on which information is write once or rewritable, the information-recording medium comprising:
recording tracks which are formed in a spiral form and which meander at a predetermined wobble cycle T; and
a plurality of zones which constitute each of the recording tracks, each of the zones having a principal area formed to have a predetermined wobble phase, wherein:
the following relationship holds between the wobble cycle T and a channel bit length b of recording data:
T>80b; and
the wobble phase of the predetermined zone of one of the recording tracks is adjusted so that an average phase difference d between the wobble phase in the principal area in the zone and a wobble phase of an area in the recording track disposed adjacently on an inner circumferential side or an outer circumferential side of the principal area is as follows in relation to all of the recording tracks:
d>π/2.

2. The information-recording medium according to claim 1, wherein a length of the predetermined zone is adjusted so that the average phase difference d is d>π/2.

3. The information-recording medium according to claim 2, wherein a wobble phase of an area other than the principal area in the zone is opposite to the wobble phase of the principal area, and the length of the zone is an integral multiple of T/2.

4. The information-recording medium according to claim 2, wherein wobbles, which are formed in the principal areas of the predetermined zones disposed adjacently in a circumferential direction, have the phases which are opposite to one another.

5. The information-recording medium according to claim 2, wherein a wobble amplitude of at least a part of an area other than the principal area in the zone is different from a wobble amplitude of the principal area.

6. The information-recording medium according to claim 2, wherein an identifier, which indicates a boundary of the zone, is provided at one end of the zone in a circumferential direction.

7. An information-recording medium on which information is write once or rewritable, the information-recording medium comprising:
recording tracks which are formed in a spiral form and which meander at a predetermined wobble cycle T; and
a plurality of zones which constitute each of the recording tracks, each of the zones having a principal area formed to have a predetermined wobble phase, wherein:
the following relationship holds between the wobble cycle T and a channel bit length b of recording data:
T>80b; and
the wobble phase of the predetermined zone of one of the recording tracks is inverted so that an average phase difference d between the wobble phase in the principal area in the zone and a wobble phase of an area in the recording track disposed adjacently on an inner circumferential side or an outer circumferential side of the principal area is as follows in relation to all of the recording tracks:
d>π/2.

8. The information-recording medium according to claim 7, wherein an identifier is provided at one end of the zone in a circumferential direction, the identifier expressing information about a wobble phase of another zone disposed adjacently to the end.

9. The information-recording medium according to claim 7, wherein a length of the zone is 1/n time an ECC block unit provided that n is an integer.

10. An information-recording/reproducing apparatus which records or reproduces information on an information-recording medium on which the information is write once or rewritable and in which recording tracks meandering at a predetermined wobble cycle are formed in a spiral form, each of the recording tracks includes a plurality of zones, each of the zones has a principal area formed to have a predetermined wobble phase, and the phases of wobbles formed in the principal areas of predetermined zones disposed adjacently in a circumferential direction are opposite to one another, the information-recording/reproducing apparatus comprising:
a spindle;
a detector which detects a wobble signal from the information-recording medium; and
a control unit which controls a number of revolutions of the spindle on the basis of the detected wobble signal.

11. The information-recording/reproducing apparatus according to claim 10, wherein the control unit includes a circuit which multiplies, by an even number, a frequency of the detected wobble signal.

12. The information-recording/reproducing apparatus according to claim 10, wherein the control unit includes a circuit which converts the detected wobble signal into a binary signal.

13. An information-recording/reproducing apparatus which records or reproduces information on an information-recording medium which is formed with information tracks each meandering at a predetermined wobble cycle, the information-recording/reproducing apparatus comprising:
an optical pickup;
a unit which detects a wobble signal from the information-recording medium;
a unit which detects an area in which a wobble phase of a predetermined information track of the information tracks in the information-recording medium is substantially opposite to wobble phases of information tracks disposed adjacently on both sides of the predetermined information track in a radial direction, or an area in which no wobble is formed on the information tracks disposed adjacently on the both sides of the predetermined information track in the radial direction; and
an aberration-correcting unit which corrects a relative inclination of the optical pickup with respect to the information-recording medium on the basis of the wobble signal obtained from the area.

14. The information-recording/reproducing apparatus according to claim 13, wherein the aberration-correcting unit determines an amount of correction of the relative inclination of the optical pickup with respect to the information-recording medium by performing calculation with peak values of the wobble signal.

15. A phase-adjusting method for recording tracks of an information-recording medium on which information is write once or rewritable and in which the recording tracks meandering at a predetermined wobble cycle T are formed in a spiral form, and each of the recording tracks includes a plurality of zones, the phase-adjusting method comprising:
determining a wobble phase difference d between the recording tracks disposed adjacently in a radial direction; and
adding a predetermined phase to a wobble phase of the predetermined zone included in at lease one recording track of the recording tracks disposed adjacently in the radial direction so that the wobble phase difference d is d>π/2 between the recording tracks disposed adjacently in the radial direction in which the wobble phase difference d would be otherwise d≦π/2.
